(19) United States
(12) Patent Application Publication
(10) Pub. No.: US 2015/0062319 A1
(43) Pub. Date: Mar. 5, 2015

(54) AUTHENTICATION APPARATUS, PRISM MEMBER FOR AUTHENTICATION AND AUTHENTICATION METHOD

(71) Applicant: NEC Corporation, Tokyo (JP)

(72) Inventor: Teruyuki Higuchi, Tokyo (JP)

(21) Appl. No.: 14/388,828

(22) PCT Filed: Mar. 26, 2013
(86) PCT No.: PCT/JP2013/058736

§ 371 Date: Sep. 29, 2014

(30) Foreign Application Priority Data
Mar. 27, 2012 (JP) 2012-071921

(51) Int. Cl. G06K 9/00; G01N 21/47; G02B 5/04; G01N 21/3563

(52) U.S. Cl. CPC G06K 9/00906; G01N 21/3563; G01N 21/47; G02B 5/04; G06K 9/00362; G06K 2209/05
USPC 348/77; 359/350

(57) ABSTRACT

An authentication apparatus includes a prism, an imaging unit, a visible light source and an infrared light source. The prism comprises: a contact surface contacted with the living body; a reflection surface contacted with the contact surface, and totally reflect light by the visible light source from a concave portion of the living body and a convex portion of the living body, and light by the infrared light source from an inside of the living body; and an imaging surface configured to be opposed to the contact surface, in contact with the reflection surface, and provided at an angle such that the light from the concave portion of the living body cannot be reached, and the light totally reflected by the reflection surface and the light from the convex portion of the living body can be transmitted. The imaging unit images the light which is transmitted through the imaging surface.

### TECHNICAL FIELD

The present invention relates to an authentication apparatus, a prism member for authentication and an authentication method.

### BACKGROUND ART

The apparatus for determining a subject as a forged finger when the color of the image acquired by reflecting visible light of forgery-determining illumination on the subject does not coincide with that of the finger image that has been acquired likewise and has been previously registered in data storing means is described in Patent literature 1. The same apparatus collates a characteristic point obtained from the transmitted light by radiating near-infrared ray of individual identification illumination to the finger with the characteristic point of the finger image that has been acquired likewise and has been previously registered into the data storing means, and performs the individual identification.

The apparatus for selectively switching white light and infrared light, reflecting the white light on a surface layer portion of the finger thereby to acquire the fingerprint image, making the infrared ray incident inside the finger and scattering the infrared ray thereby to acquire a vein image, comparing the fingerprint image and the vein image with the registered fingerprint image and the registered vein image, respectively, and authenticating a specific personal is described in Patent literature 2.

The apparatus for comparing the fingerprint image with high sensitivity with the fingerprint image with low sensitivity, and determining the forged finger is described in Patent literature 3.

The apparatus for, based on a difference of the finger vein images imaged with the transmitted lights having a different wavelength, determining whether the above finger vein image is the finger vein image of a living body is described in Patent literature 4.

On the other hand, the technique of using a prism as a scanner for the fingerprint authentication, and augmenting a contrast is described in Patent literature 5.

### CITATION LIST

### Patent Literature

[PATENT LITERATURE 1]

### Japanese Unexamined Patent Application Publication No. 2007-122237

[PATENT LITERATURE 2]

### Japanese Unexamined Patent Application Publication No. 2007-179434

[PATENT LITERATURE 3]

### Japanese Unexamined Patent Application Publication No. 2007-259964

[PATENT LITERATURE 4]

### Japanese Unexamined Patent Application Publication No. 2008-67727

[PATENT LITERATURE 5]
   U.S. Pat. No. 6,381,347

### SUMMARY OF INVENTION

### Technical Problem

Recently, the criminal actions such as using a finger forged with resin such as silicon, or “impersonating” others by affixing a semi-transparent forged film of the fingerprint having concave and convex to the tip of a genuine finger have been increasing

In order to detect such actions, it is conceivable to obtain a natural image of a finger close to the visibility for detecting forgery and check it by the visibility, in addition to a high contrast image for collating a fingerprint and the like.

However, any of the above-described Patent literatures 1 to 4 cannot detect the forgery of the above finger at a high precision, comparing between the reflected light image and the transmitted light image that are obtained from the identical finger.

Further, the technique of the Patent literature 5 as well can obtain the image with a high contrast necessary for the collation of the fingerprint; however, the Patent literature 5 cannot detect the forgery of the finger at a high precision similarly to the techniques of the above-described Patent literatures 1 to 4 because only the image of the portion in contact with the prism is obtained.

Further, when imaging a high contrast image and a natural image of a finger close to the visibility for detecting forgery, an imaging apparatus is required for imaging each image, thereby causing a problem that an authentication apparatus becomes larger.

Further, when imaging a vessel pattern inside the living body to enhance an accuracy of authentication by using an infrared light, the imaging apparatus for imaging an image such as a vessel pattern by the infrared light is also required, in addition to the imaging apparatus for imaging a high contrast image and the imaging apparatus for imaging a natural image, thereby causing a problem that the authentication apparatus becomes further larger.

Therefore, the present invention has been accomplished in consideration of the above-mentioned problem, and an object of the present invention is to provide an authentication apparatus, a prism member for authentication and an authentication method, which are capable of obtaining a high contrast image with sufficient contrast for collating a living body, an natural image of the living body close to the visibility, and an image such as a vessel pattern by an infrared light, simultaneously with a single imaging apparatus.

### Solution to Problem

The present invention is an authentication apparatus including a prism body, an imaging unit, a visible light source configured to radiate a visible light to a living body and an infrared light source configured to radiate an infrared light to the living body, wherein the prism body comprises: a living body contact surface configured to be in contact with the living body; a reflection surface configured to be in contact with the living body contact surface, and totally reflect light by the visible light source from a concave portion of the living body and a convex portion of the living body, and light by the infrared light source from an inside of the living body; and an imaging surface configured to be opposed to the living body contact surface, in contact with the reflection surface, and provided at an angle such that the light from the concave portion of the living body cannot be reached, and the light totally reflected by the reflection surface and the light from the convex portion of the living body can be transmitted, wherein the imaging unit is configured to image the light, which is transmitted through the imaging surface, from the convex portion of the living body, the light, which is transmitted through the imaging surface and reflected by the reflection surface, from the concave portion of the living body and the convex portion of the living body, and the light, which is transmitted through the imaging surface and reflected by the reflection surface, from the inside of the living body, simultaneously.

The present invention is a prism body for authentication of a living body, the prism body comprising: a living body contact surface configured to be in contact with the living body; a reflection surface configured to be in contact with the living body contact surface, and totally reflect light by the visible light source from a concave portion of the living body and a convex portion of the living body, and light by the infrared light source from an inside of the living body; and an imaging surface configured to be opposed to the living body contact surface, in contact with the reflection surface, and provided at an angle such that the light from the concave portion of the living body cannot be reached, and the light totally reflected by the reflection surface and the light from the convex portion of the living body can be transmitted.

The present invention is an authentication method, comprising: causing a living body to contact with a living body contact surface of a prism body including: the living body contact surface configured to be in contact with the living body; a reflection surface configured to be in contact with the living body contact surface, and totally reflect light by the visible light source from a concave portion of the living body and a convex portion of the living body, and light by the infrared light source from an inside of the living body; and an imaging surface configured to be opposed to the living body contact surface, in contact with the reflection surface, and provided at an angle such that the light from the concave portion of the living body cannot be reached, and the light totally reflected by the reflection surface and the light from the convex portion of the living body can be transmitted, radiating a visible light and an infrared light to the living body; and imaging the light, which is transmitted through the imaging surface, from the convex portion of the living body, the light, which is transmitted through the imaging surface and reflected by the reflection surface, from the concave portion of the living body and the convex portion of the living body, and the light, which is transmitted through the imaging surface and reflected by the reflection surface, from the inside of the living body, simultaneously.

### Advantageous Effect of Invention

The present invention makes it possible to obtain a high contrast image with sufficient contrast for collating a living body, a natural image of the living body close to the visibility, and an image such as a vessel pattern by an infrared light, simultaneously with a single imaging apparatus.

### BRIEF DESCRIPTION OF DRAWINGS

FIG. 1 is a diagram illustrating a configuration of a prism 1 in accordance with the present invention;

FIG. 2 is a diagram for explaining the prism 1 in accordance with the present invention;

FIG. 3 is a diagram for explaining the prism 1 in accordance with the present invention;

FIG. 4 a diagram for explaining the prism 1 in accordance with the present invention;

FIG. 5 a diagram for explaining the prism 1 in accordance with the present invention;

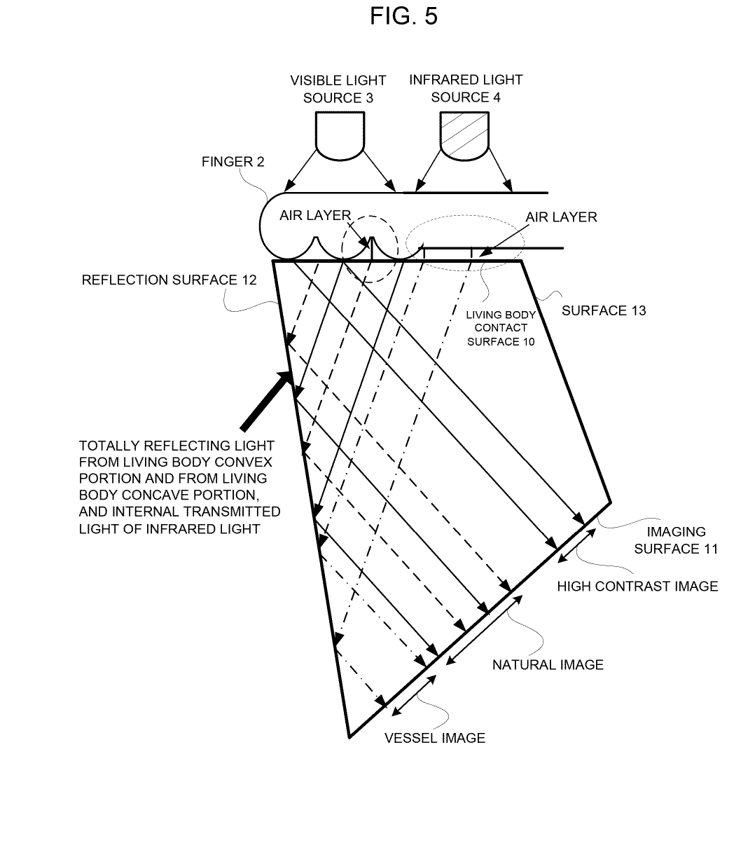

FIG. 6 is a configuration diagram of a fingerprint authentication apparatus in accordance with a first embodiment of the present invention;

FIG. 7 is a diagram illustrating an example of a high contrast image, a natural image and a vessel pattern image imaged by an imaging apparatus 4;

FIG. 8 is a configuration diagram of a prism 7 in accordance with a second embodiment of the present invention;

FIG. 9 is a configuration diagram of the authentication apparatus in accordance with the second embodiment of the present invention;

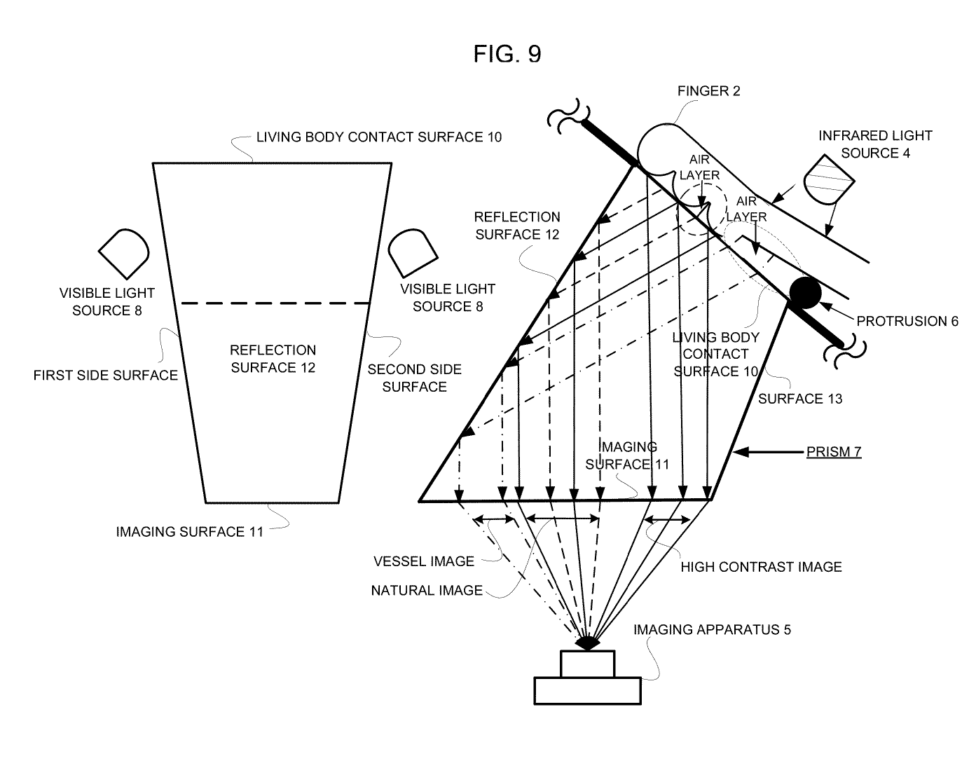

FIG. 10 is a configuration diagram of the authentication apparatus in accordance with a third embodiment of the present invention;

### DESCRIPTION OF EMBODIMENTS

Embodiments of the present invention will be described.

Firstly, principles of a prism in accordance with the present invention will be described.

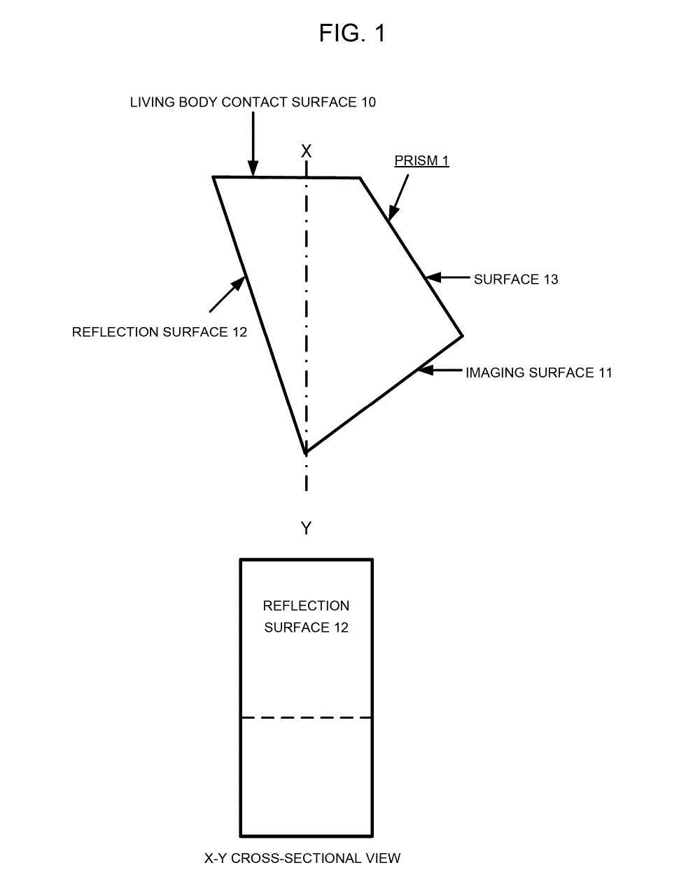

FIG. 1 is a diagram illustrating a configuration of a prism 1 in accordance with the present invention. In the figure, 10 is a living body contact surface that contacts with a living body (e.g. finger), 11 is an imaging surface that is provided opposed to the living body contact surface 10 and that is a surface of a side on which an imaging apparatus such as a camera is arranged, and 12 is a reflection surface 12 that is provided in contact with the living body contact surface 10 and the imaging surface 11.

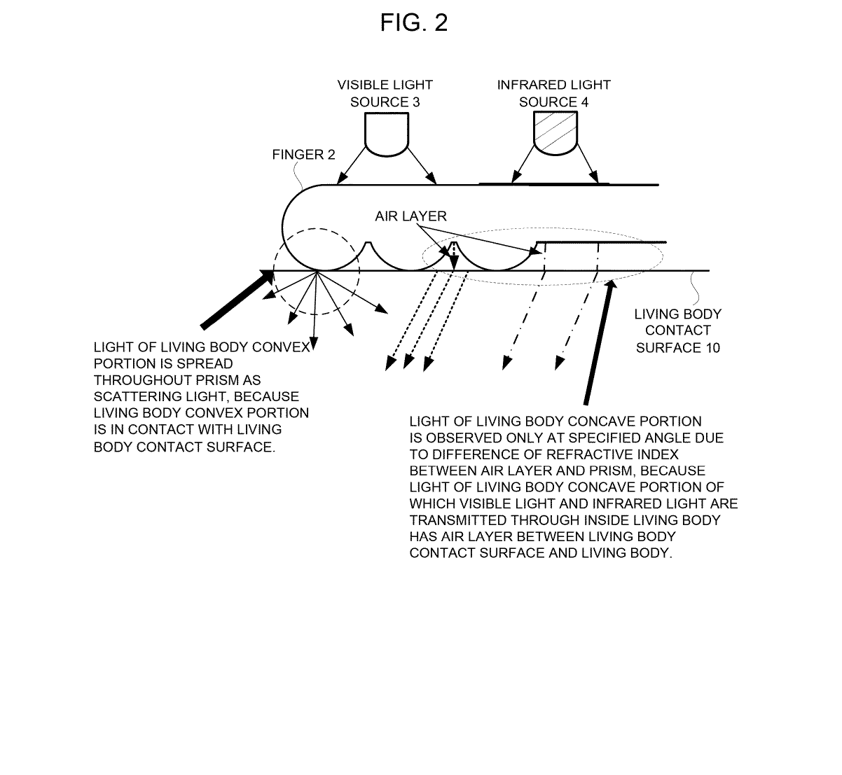

Next, a light path when a living body 2 is in contact with the living body contact surface 10 will be described with reference to FIG. 2. Note that, in the following description, a living body will be described as a finger, but it is not limited thereto. For example, it is also possible to be used in palm pattern authentication of a palm. Further, in the example, a visible light source 3 is provided in an upper side of a fingernail of a fingertip of the finger 2 to make a radiated light penetrate inside the living body from a nail side of the fingertip 2, and make the radiated light move therein while being scattered. As to a wavelength of the radiated light of the visible light source 3, it is preferable to use a wavelength with high transmittance for the living body. Further, an infrared light source 20 for an infrared light is provided at an upper side than where the finger 2 is not compressed by the living body contact surface 10 to make the radiated light penetrate inside the living body from an upper side of the fingertip 2, and make the radiated light move therein while being scattered.

A light of the visible light source 3 having penetrated the inside of the living body from the finger 2 reaches the living body contact surface 10 while being absorbed and scattered by tissues such as cells, and is radiated as a scattering light from a living body convex portion (ridge portion of fingerprint) and a living body concave portion (portions not in contact with living body contact surface 10 such as valley portion of fingerprint or finger pad portion). At this time, the scattering light is radiated to all directions at almost 180 degrees, because the living body is an excellent scatterer. Thus, the scattering light output from the living body convex portion (ridge portion of fingerprint) can reach all areas lower than the living body contact surface 10.

On the other hand, the scattering light output from the living body concave portion (portions not in contact with living body contact surface 10 such as valley portion of fingerprint or finger pad portion) is incident on the prism 1 through an air layer. But, a refraction index of air is 1.0, a refraction index of glass is 1.3 to 1.5, and a refraction index of water and skin is 1.3 to 1.4, that is to say, since each reflective index differs from each other, so that a reflection and a refraction phenomenon generated in the light from the living body concave portion are different from those generated in the light from the living body convex portion. Accordingly, the light from the living body convex portion is observed from all direction, while the light from the living body concave portion is observed only at a specified angle.

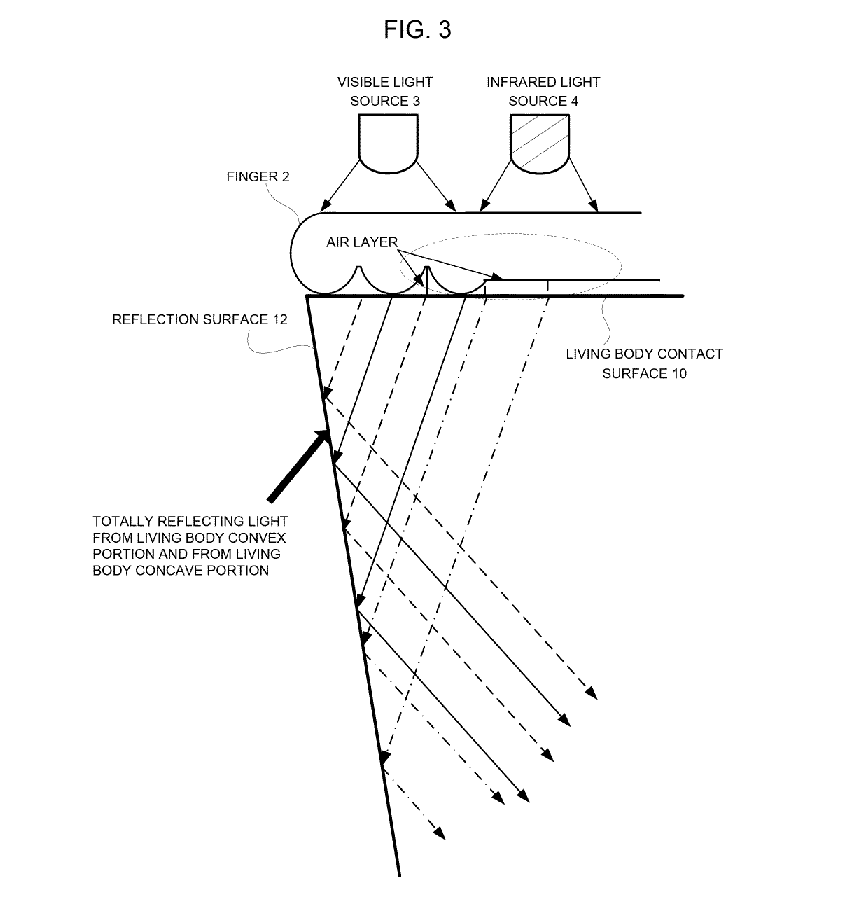

Thus, as shown in FIG. 3, in a position where light incident on a prism from the living body concave portion (portions not in contact with living body contact surface 10 such as valley portion of fingerprint or finger pad portion) of the finger 2 through an air layer can be observed, the reflection surface 12 is provided to be an angle more than an optimum angle for the living body convex portion (ridge portion of fingerprint) and the living body concave portion (portions not in contact with living body contact surface 10 such as valley portion of fingerprint or finger pad portion), and incident light from the living body convex portion and the living body concave portion, thereby totally reflecting the light from the living body convex portion (ridge portion of fingerprint) and the living body concave portion (portions not in contact with living body contact surface 10 such as valley portion of fingerprint or finger pad portion), and the infrared light.

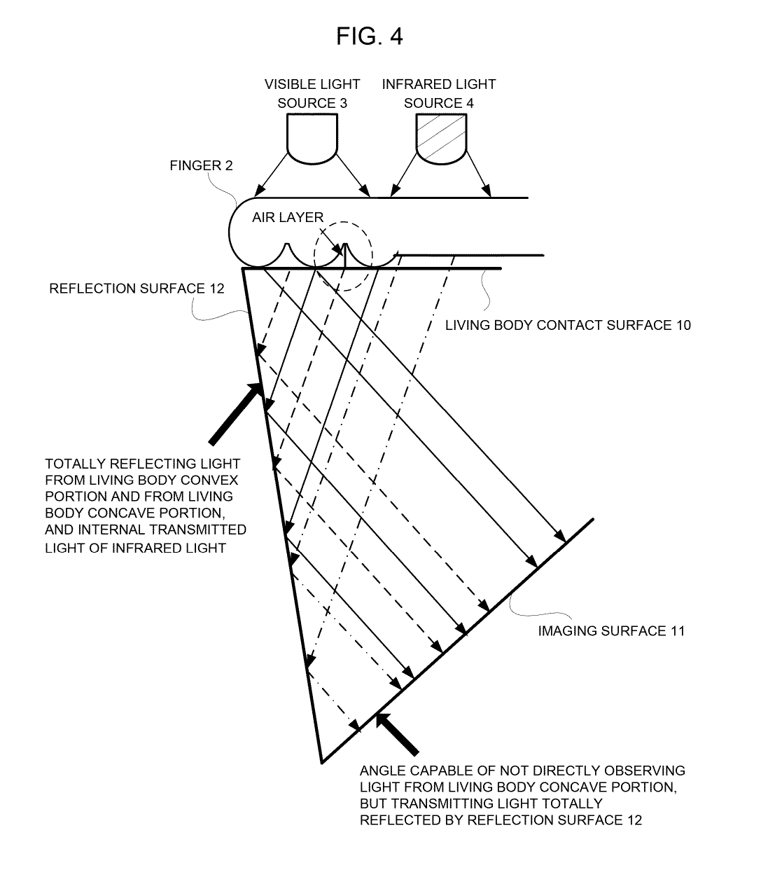

Next, as shown in FIG. 4, the imaging surface 11 is provided in a position where the light from the living body concave portion cannot be directly observed, and at an angle capable of transmitting the light (visible light from living body convex portion and living body concave portion, and infrared light from non-contact portion) totally reflected by the reflection surface 12.

This allows that a high contrast image for authentication of a living body (hereinafter, it will be referred to as “high contrast image”) whose the living body concave portion is dark and the living body convex portion is bright is captured on an upper part of the imaging surface 11, because only the light from the living body convex portion is transmitted to the imaging surface 11, but the light from the living body concave portion cannot be reached at an upper portion of the imaging surface 11. On the other hand, a natural image consisting of the light from the living body concave portion and the light from the living body convex portion is captured on a middle part of the imaging surface 11, because both the light incident from the living body concave portion and the light incident from the living body convex portion, both of which are totally reflected from the reflection surface 12, are transmitted to a lower part of the imaging surface 11. Further, an image by an infrared light totally reflected by the reflection surface 12, that is to say, an image of a vessel pattern (vessel pattern image) inside the finger 2 is captured on a lower part of the imaging surface 11.

Note that a surface 13 is provided in contact with the living contact surface 10 and the imaging surface 11, so as to capture the high contrast image, the natural image and the vessel pattern image, and to have a size capable of sufficiently ensuring a contact area between the living body and the living body contact surface 10 for obtaining a sufficiently large image required for authentication of the living body, and capable of imaging the vessel pattern image.

The use of a prism described above in an authentication apparatus makes it possible to capture a high contrast image, a natural image and a vessel pattern image on the imaging surface 11 at one time, thereby, when using an imaging apparatus with an element and a filter sensitive to an infrared light and an element and a color filter only sensitive to a visible area, being able to image the high contrast image, the natural image and the vessel pattern image of the living body by a single imaging apparatus.

Further, since the high contrast image takes an image coming straight from the living body contact surface, so that it is not necessary to provide a reflection surface, and a mirror coat is also not necessary, because the refection surface 12 is configured to be totally reflected, thereby being able to reduce costs for the prism body.

### First Embodiment

A first embodiment of the present invention will be described.

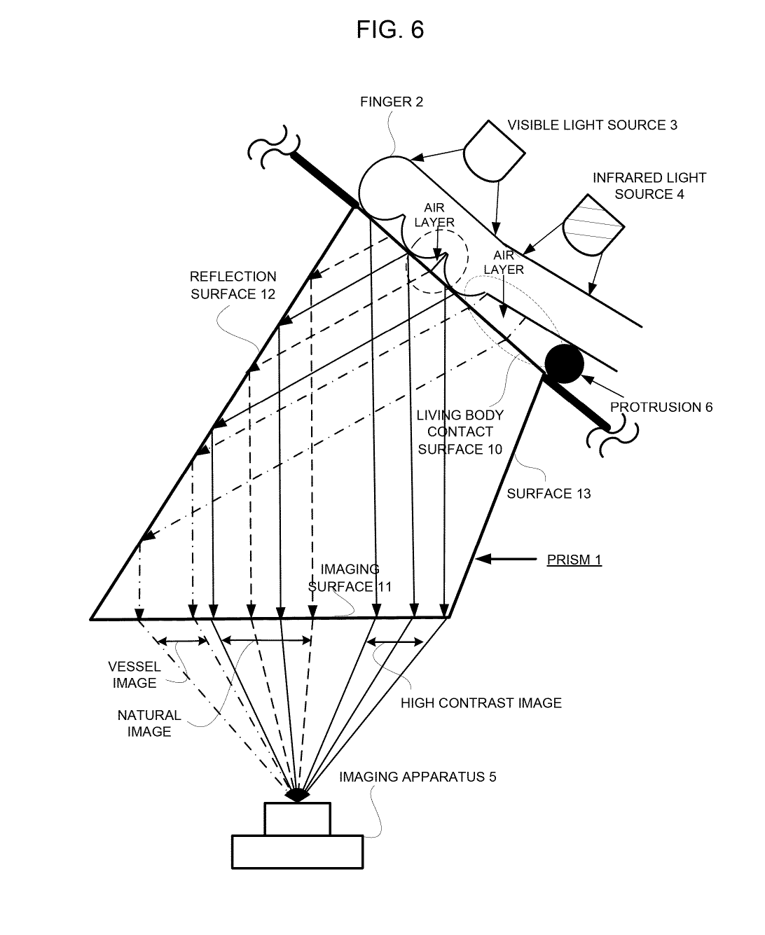

FIG. 6 is a configuration diagram of a fingerprint authentication apparatus in accordance with a first embodiment of the present invention.

In the fingerprint authentication apparatus of the first embodiment, the prism 1 described above is provided at a position where the living body contact surface 10 is provided in an upper side of the apparatus and a fingerprint of the finger 2 is placed thereon. Further, a protrusion 6 is provided not to lose a blood current by compressing a vessel in a site between a first joint and a second joint of the finger 2 with the living body contact surface 10.

Then, the visible light source 3 is provided in an upper side of a fingernail of a fingertip of the finger 2 to make an radiated light penetrate inside the living body from a nail side of the fingertip 2 and make the radiated light move therein while being scattered. As to a wavelength of the radiated light of the visible light source 3, it is obvious to use a wavelength with high transmittance for the living body, for example, the wavelength indicates a relatively high transmittance in a range of wavelengths from 0.6 micrometers to 1.4 micrometers, so that it is effective as a wavelength of the light source of the present invention. Further, although a type of the visible light source 3 is not limited, LED may be used because it is cheap with high brightness.

An infrared light source 4 is provided at an upper of the site between the first joint and the second joint of the finger 2.

Further, an imaging apparatus 5 is provided at a lower portion of the imaging surface 11 side of the prism 1 through the imaging surface 11, the imaging apparatus 5 for imaging a high contrast image in which the ridge portion and the valley portion of fingerprints are clear, a natural image of a fingerprint part of the finger, and a vessel pattern image of a vessel in the site between the first joint and the second joint of the finger 2. The imaging apparatus 5 is an imaging apparatus having an element and a filter sensitive to an infrared light and an element and a color filter only sensitive to a visible area, and a CMOS sensor capable of obtaining an infrared image and a normal RGB image, simultaneously. Note that other configurations are also possible, unless the imaging apparatus is capable of obtaining the infrared image and the normal RGB image, simultaneously.

Next, operations of the living body authentication apparatus described above will be described.

Firstly, in performing authentication, the finger 2 is placed on the living body contact surface 10 of the prism 1 that is a placing surface.

The visible light source 3 and the infrared light source 4 emit light in a situation that a fingerprint part of the finger 2 is placed on the living body contact surface 10, and radiate the light for photography to the finger 2.

The light of the visible light source 3 and the infrared light source 4 having penetrated inside the living body from the finger 2 reaches the living body contact surface 10 while being absorbed and scattered by tissues such as cells, and is radiated as a scattering light from a ridge portion of the fingerprint and a valley portion of the fingerprint, and from the site between the first joint and the second joint of the finger 2.

Next, the scattering light output from the ridge portion of the fingerprint reaches all areas lower than the living body contact surface 10 and transmits through the imaging surface 11, while the scattering light is reflected on the imaging surface 11 by the reflection surface 12. On the other hand, the scattering light output from the valley portion of the fingerprint and the site between the first joint and the second joint of the finger 2 is incident on the prism 1 through an air layer, and reflected on the imaging surface 11 by the reflection surface 12, together with the scattering light output from the ridge portion of the fingerprint.

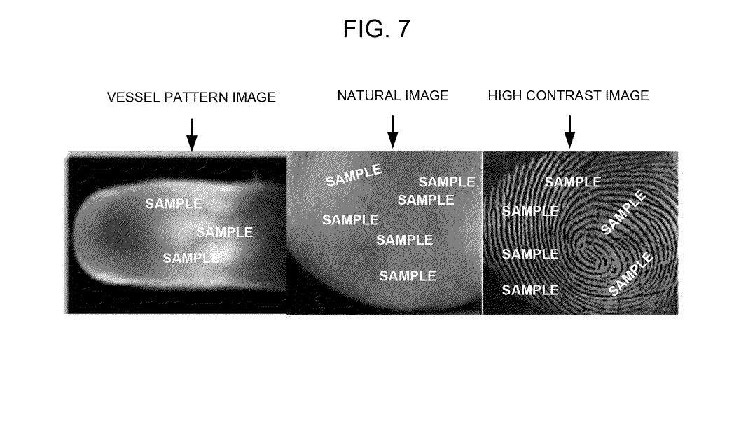

The imaging apparatus 5 images a high contrast image of the fingerprint part of the finger 2 and a natural mage thereof, and a vessel pattern image of the site between the first joint and the second joint of the finger 2 by only one-time photography, using the light transmitted through the imaging surface 11 of the prism 1. An example of an image imaged by the imaging apparatus 5 will be shown in FIG. 7. As shown in FIG. 7, it is understood that the high contrast image of the fingerprint part and the natural image of the finger 2 including the fingerprint part, and the vessel pattern image of the site between the first joint and the second joint of the finger 2 are imaged.

By extracting and collating an amount of characteristic from the high contrast image and the vessel pattern image of the site between the first joint and the second joint of the finger 2, both of which obtained in this manner, it is possible to collate and authenticate a fingerprint. Further, as to the natural image, by displaying the imaged image on a display device and checking the image with the visibility, or by using predetermined collation algorism, it is possible to determine whether a forged film or tape is used in performing authentication.

Like this, the authentication apparatus of the first embodiment makes it possible to obtain a natural image, which is close to the visibility, for determining whether a forged film or tape is used, and a high contrast image and a vessel patter image used for collating a living body (fingerprint and vessel pattern image) by only a single imaging apparatus as well as only one-time photography of a finger. Further, a prism body is produced cheaply because it is not necessary to provide a reflector such as a mirror coat for reflecting light on the imaging surface 11 on the reflection surface 12 of the prism 1, thereby being able to reduce costs for the whole authentication apparatus.

### Second Embodiment

A second embodiment of the present invention will be described.

In an authentication apparatus of the fourth embodiment, a shape of a prism differs from the one of the prism 1 used in the above-described embodiment of the present invention.

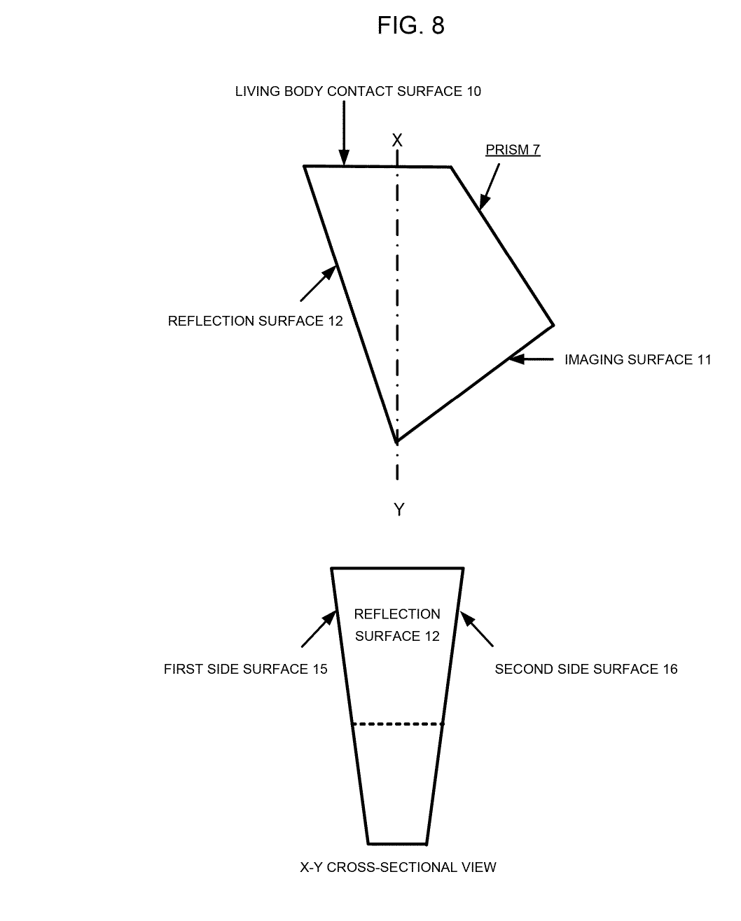

FIG. 8 is a configuration diagram of a prism 7 in accordance with the authentication apparatus of the second embodiment of the present invention. As shown in FIG. 2, what the prism 7 differs from a shape of the prism 1 is that a first side surface 15 and a second side surface 16 of the prism 7 is formed such that an angle made by the living body contact surface 10 is to be smaller than 90 degrees. That is, the difference is that a taper is attached for the imaging surface 11 opposed to the living body contact surface 10. Note that the imaging surface 11 and the reflection surface 12 are provided at the same angle as that of the prism 1.

The above configuration of the prism 5 makes it possible to use a reflected light source as a visible light source, not a transmitted light source, thereby being able to provide a light source position of the visible light source at a lower part of the prism 5.

FIG. 11 is a configuration diagram of the authentication apparatus in accordance with a second embodiment of the present invention.

A visible light source 8 for irradiating light is provided on the first side surface 15 and the second side surface 16 of the prism 7. As to a wavelength of the radiated light of the visible light source 8, it is obvious to use a wavelength with high transmittance for the living body, for example, the wavelength indicates a relatively high transmittance in a range of wavelengths from 0.6 micrometers to 1.4 micrometers, so that it is effective as a wavelength of the light source of the present invention. Further, although a type of the visible light source 7 is not limited, LED may be used because it is cheap with high brightness.

Next, operations of the living body authentication apparatus described above will be described.

Firstly, in performing authentication, the finger 2 is placed on the living body contact surface 10 of the prism 1 that is a placing surface.

The visible light source 7 and the infrared light source 4 emit light in a situation that a fingerprint part of the finger 2 is placed on the living body contact surface 10, and radiate the light for photography to the finger 2.

The light of the visible light source 3 and the infrared light source 4 having penetrated inside the living body from the finger 2 reaches the living body contact surface 10 again, while being absorbed and scattered by tissues such as cells, and is radiated as a scattering light from a ridge portion of the fingerprint and a valley portion of the fingerprint, and from the site between the first joint and the second joint of the finger 2.

Next, the scattering light output (reflected on the living body contact surface 10) from the ridge portion of the fingerprint reaches all areas lower than the living body contact surface 10 and transmits through the imaging surface 11, while the scattering light is reflected on the imaging surface 11 by the reflection surface 12. On the other hand, the scattering light output from the valley portion of the fingerprint and the site between the first joint and the second joint of the finger 2 is incident on the prism 1 through an air layer, and reflected on the imaging surface 11 by the reflection surface 12, together with the scattering light output from the ridge portion of the fingerprint.

The imaging apparatus 5 images a high contrast image of the fingerprint part of the finger 2 and a natural mage thereof, and a vessel pattern image of the site between the first joint and the second joint of the finger 2 by only one-time photography, using the light passing through the imaging surface 11 of the prism 1.

The authentication apparatus of the fourth embodiment has the same effect as that of the first embodiment, but the authentication apparatus can be more reduced in size as compared with the case that a visible light source is provided at an upper part of the living body, because the visible light source radiating a visible light to the living body is provided at a lower part of the prism.

### Third Embodiment

A third embodiment of the present invention will be described.

The third embodiment differs from the second embodiment in that an infrared light source 9 is provided at a lower part of the first side surface 15 and the second side surface 16 of the prism 7 respectively, as is the case in the visible light source 8, instead of the infrared light source 4 provided at an upper part of the authentication apparatus of the second embodiment.

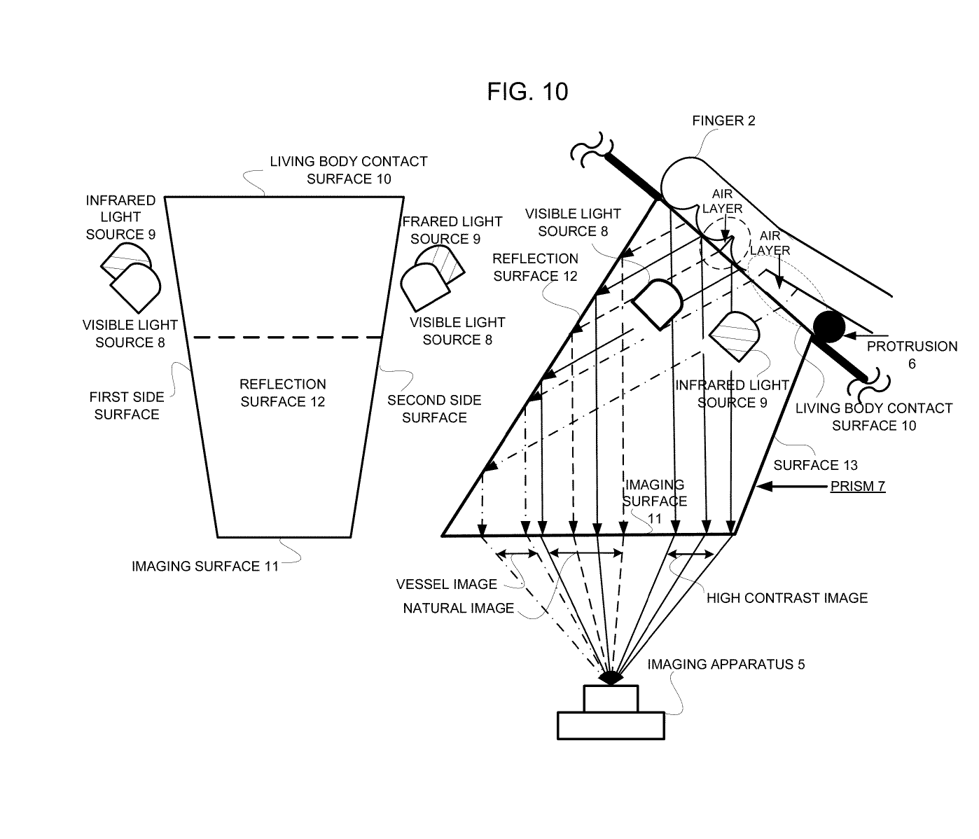

FIG. 10 is a configuration diagram of the authentication apparatus in accordance with the third embodiment of the present invention.

The visible light source and the infrared light source 9 irradiating light is respectively provided at the first side surface 15 and the second side surface 16 of the prism 7.

Next, operations of the living body authentication apparatus described above will be described.

Firstly, in performing authentication, the finger 2 is placed on the living body contact surface 10 of the prism 1 that is a placing surface.

The visible light source 7 and the infrared light source 9 emit light in a situation that a fingerprint part of the finger 2 is placed on the living body contact surface 10, and radiate the light for photography to the finger 2.

The light of the visible light source 3 and the infrared light source 9 having penetrated inside the living body from the finger 2 reaches the living body contact surface 10 again, while being absorbed and scattered by tissues such as cells, and is radiated as a scattering light from a ridge portion of the fingerprint and a valley portion of the fingerprint, and from the site between the first joint and the second joint of the finger 2.

Next, the scattering light output (reflected on the living body contact surface 10) from the ridge portion of the fingerprint reaches all areas lower than the living body contact surface 10 and transmits through the imaging surface 11, while the scattering light is reflected on the imaging surface 11 by the reflection surface 12. On the other hand, the scattering light output from the valley portion of the fingerprint and the site between the first joint and the second joint of the finger 2 is incident on the prism 1 through an air layer, and reflected on the imaging surface 11 by the reflection surface 12, together with the scattering light output from the ridge portion of the fingerprint.

The imaging apparatus 5 images a high contrast image of the fingerprint part of the finger 2 and a natural mage thereof, and a vessel pattern image of the site between the first joint and the second joint of the finger 2 by only one-time photography, using the light passing through the imaging surface 11 of the prism 1.

The authentication apparatus of the third embodiment has the same effect as that of the first and the second embodiments, but the authentication apparatus can be more reduced in size as compared with the case that a visible light source and an infrared light source are provided at an upper part of the living body, because the visible light source and the infrared light source, both of which respectively radiate a visible light and an infrared light to the living body, are provided at a lower part of the prism.

One part or an entirety of the above embodiments can be described as the following supplementary notes, but the present invention is not limited to the followings.

(Supplementary Note 1) An authentication apparatus including a prism body, an imaging unit, a visible light source configured to radiate a visible light to a living body and an infrared light source configured to radiate an infrared light to the living body,

wherein the prism body comprises:

a living body contact surface configured to be in contact with the living body;

a reflection surface configured to be in contact with the living body contact surface, and totally reflect light by the visible light source from a concave portion of the living body and a convex portion of the living body, and light by the infrared light source from an inside of the living body; and

an imaging surface configured to be opposed to the living body contact surface, in contact with the reflection surface, and provided at an angle such that the light from the concave portion of the living body cannot be reached, and the light totally reflected by the reflection surface and the light from the convex portion of the living body can be transmitted,

wherein the imaging unit is configured to image the light, which is transmitted through the imaging surface, from the convex portion of the living body, the light, which is transmitted through the imaging surface and reflected by the reflection surface, from the concave portion of the living body and the convex portion of the living body, and the light, which is transmitted through the imaging surface and reflected by the reflection surface, from the inside of the living body, simultaneously.

(Supplementary Note 2) The authentication apparatus according to supplementary note 1, wherein:

an image configured to image light directly reaching the imaging surface, the light by the visible light source from the convex portion of the living body, is a high contrast image for authentication of the living body,

an image configured to image light reflected by the reflection surface, the light by the visible light source from the concave portion of the living body and the convex portion of the living body, is a natural image, and

an image configured to image light reflected by the reflection surface, the light by the infrared light source from the inside of the living body, is a vessel image pattern.

(Supplementary Note 3) The authentication apparatus according to supplementary note 1 or 2, wherein:

the visible light source and the infrared light source are arranged at an upper part of the living body.

(Supplementary Note 4) The authentication apparatus according to supplementary note 1 or 2, wherein:

a first side surface and a second side surface of the prism body are formed such that an angle made by the living body contact surface is to be smaller than 90 degrees,

the visible light source is arranged at a lower part of the first side surface and the second side surface, and

the infrared light source is arranged at an upper part of the living body.

(Supplementary Note 5) The authentication apparatus according to supplementary note 1 or 2, wherein:

a first side surface and a second side surface of the prism body are formed such that an angle made by the living body contact surface is to be smaller than 90 degrees,

the visible light source and the infrared light source are arranged at a lower part of the first side surface and the second side surface of the prism body.

(Supplementary Note 6) The authentication apparatus according to any of supplementary notes 1 to 5, wherein the living body is a human's finger.

(Supplementary Note 7) A prism body for authentication of a living body, the prism body comprising:

a living body contact surface configured to be in contact with the living body;

a reflection surface configured to be in contact with the living body contact surface, and totally reflect light by the visible light source from a concave portion of the living body and a convex portion of the living body, and light by the infrared light source from an inside of the living body; and

an imaging surface configured to be opposed to the living body contact surface, in contact with the reflection surface, and provided at an angle such that the light from the concave portion of the living body cannot be reached, and the light totally reflected by the reflection surface and the light from the convex portion of the living body can be transmitted.

(Supplementary Note 8) The prism body for authentication of a living body according to supplementary note 7, wherein a first side surface and a second side surface of the prism body are formed such that an angle made by the living body contact surface is to be smaller than 90 degrees.

(Supplementary Note 9) An authentication method, comprising:

causing a living body to contact with a living body contact surface of a prism body including:
the living body contact surface configured to be in contact with the living body;
a reflection surface configured to be in contact with the living body contact surface, and totally reflect light by the visible light source from a concave portion of the living body and a convex portion of the living body, and light by the infrared light source from an inside of the living body; and
an imaging surface configured to be opposed to the living body contact surface, in contact with the reflection surface, and provided at an angle such that the light from the concave portion of the living body cannot be reached, and the light totally reflected by the reflection surface and the light from the convex portion of the living body can be transmitted,

radiating a visible light and an infrared light to the living body; and

imaging the light, which is transmitted through the imaging surface, from the convex portion of the living body, the light, which is transmitted through the imaging surface and reflected by the reflection surface, from the concave portion of the living body and the convex portion of the living body, and the light, which is transmitted through the imaging surface and reflected by the reflection surface, from the inside of the living body, simultaneously.

(Supplementary Note 10) The authentication method according to supplementary note 9, wherein:

an image configured to image light directly reaching the imaging surface, the light by the visible light source from the convex portion of the living body, is a high contrast image for authentication of the living body,

an image configured to image light reflected by the reflection surface, the light by the visible light source from the concave portion of the living body and the convex portion of the living body, is a natural image, and

an image configured to image light reflected by the reflection surface, the light by the infrared light source from the inside of the living body, is a vessel image pattern.

(Supplementary Note 11) The authentication method according to supplementary note 9 or 10, further comprising:

radiating a visible light and an infrared light from an upper part of the living body.

(Supplementary Note 12) The authentication method according to supplementary note 9 or 10, further comprising:

forming a first side surface and a second side surface of the prism body such that an angle made by the living body contact surface is to be smaller than 90 degrees;

radiating a visible light from a lower part of the first side surface and the second side surface to the first side surface and the second side surface; and

radiating an infrared light from an upper part of the living body.

(Supplementary Note 13) The authentication method according to supplementary note 9 or 10, further comprising:

forming a first side surface and a second side surface of the prism body such that an angle made by the living body contact surface is to be smaller than 90 degrees; and

radiating a visible light and an infrared light from a lower part of the first side surface and the second side surface to the first side surface and the second side surface.

Above, while the present invention has been particularly shown and described with reference to embodiments, the present invention is not limited to the above mentioned embodiments. It will be understood by those of ordinary skill in the art that various changes in form and details may be made therein without departing from the spirit and scope of the present invention.

This application is based upon and claims the benefit of priority from Japanese patent application No. 2012-071921, filed on Mar. 27, 2012, the disclosure of which is incorporated herein in its entirety by reference.

### REFERENCE SIGNS LIST

1 Prism
2 Finger
3 Visible Light Source
4 Infrared Light Source
5 Imaging Apparatus
6 Protrusion
7 Prism
8 Visible Light Source
9 Infrared Light Source
10 Living Body Contact Surface
11 Imaging Surface
12 Reflection Surface
13 Surface
15 First Side Surface
16 Second Side Surface

1. An authentication apparatus including a prism body, an imaging unit, a visible light source configured to radiate a visible light to a living body and an infrared light source configured to radiate an infrared light to the living body,
wherein the prism body comprises:
a living body contact surface configured to be in contact with the living body;
a reflection surface configured to be in contact with the living body contact surface, and totally reflect light by the visible light source from a concave portion of the living body and a convex portion of the living body, and light by the infrared light source from an inside of the living body; and
an imaging surface configured to be opposed to the living body contact surface, in contact with the reflection surface, and provided at an angle such that the light from the concave portion of the living body cannot be reached, and the light totally reflected by the reflection surface and the light from the convex portion of the living body can be transmitted,
wherein the imaging unit is configured to image the light, which is transmitted through the imaging surface, from the convex portion of the living body, the light, which is transmitted through the imaging surface and reflected by the reflection surface, from the concave portion of the living body and the convex portion of the living body, and the light, which is transmitted through the imaging surface and reflected by the reflection surface, from the inside of the living body, simultaneously.

2. The authentication apparatus according to claim 1, wherein:
an image configured to image light directly reaching the imaging surface, the light by the visible light source from the convex portion of the living body, is a high contrast image for authentication of the living body,
an image configured to image light reflected by the reflection surface, the light by the visible light source from the concave portion of the living body and the convex portion of the living body, is a natural image, and
an image configured to image light reflected by the reflection surface, the light by the infrared light source from the inside of the living body, is a vessel image pattern.

3. The authentication apparatus according to claim 1, wherein:
the visible light source and the infrared light source are arranged at an upper part of the living body.

4. The authentication apparatus according to claim 1, wherein:
a first side surface and a second side surface of the prism body are formed such that an angle made by the living body contact surface is to be smaller than 90 degrees,
the visible light source is arranged at a lower part of the first side surface and the second side surface, and
the infrared light source is arranged at an upper part of the living body.

5. The authentication apparatus according to claim 1, wherein:
a first side surface and a second side surface of the prism body are formed such that an angle made by the living body contact surface is to be smaller than 90 degrees,
the visible light source and the infrared light source are arranged at a lower part of the first side surface and the second side surface of the prism body.

6. The authentication apparatus according to claim 1, wherein the living body is a human's finger.

7. A prism body for authentication of a living body, the prism body comprising:
a living body contact surface configured to be in contact with the living body;
a reflection surface configured to be in contact with the living body contact surface, and totally reflect light by the visible light source from a concave portion of the living body and a convex portion of the living body, and light by the infrared light source from an inside of the living body; and
an imaging surface configured to be opposed to the living body contact surface, in contact with the reflection surface, and provided at an angle such that the light from the concave portion of the living body cannot be reached, and the light totally reflected by the reflection surface and the light from the convex portion of the living body can be transmitted.

8. The prism body for authentication of a living body according to claim 7, wherein a first side surface and a second side surface of the prism body are formed such that an angle made by the living body contact surface is to be smaller than 90 degrees.

9. An authentication method, comprising:
causing a living body to contact with a living body contact surface of a prism body including:
the living body contact surface configured to be in contact with the living body;
a reflection surface configured to be in contact with the living body contact surface, and totally reflect light by the visible light source from a concave portion of the living body and a convex portion of the living body, and light by the infrared light source from an inside of the living body; and
an imaging surface configured to be opposed to the living body contact surface, in contact with the reflection surface, and provided at an angle such that the light from the concave portion of the living body cannot be reached, and the light totally reflected by the reflection surface and the light from the convex portion of the living body can be transmitted,
radiating a visible light and an infrared light to the living body; and
imaging the light, which is transmitted through the imaging surface, from the convex portion of the living body, the light, which is transmitted through the imaging surface and reflected by the reflection surface, from the concave portion of the living body and the convex portion of the living body, and the light, which is transmitted through the imaging surface and reflected by the reflection surface, from the inside of the living body, simultaneously.

10. The authentication method according to claim 9, wherein:
an image configured to image light directly reaching the imaging surface, the light by the visible light source from the convex portion of the living body, is a high contrast image for authentication of the living body,
an image configured to image light reflected by the reflection surface, the light by the visible light source from the concave portion of the living body and the convex portion of the living body, is a natural image, and
an image configured to image light reflected by the reflection surface, the light by the infrared light source from the inside of the living body, is a vessel image pattern.

11. The authentication method according to claim 9, further comprising:
radiating a visible light and an infrared light from an upper part of the living body.

12. The authentication method according to claim 9, further comprising:
forming a first side surface and a second side surface of the prism body such that an angle made by the living body contact surface is to be smaller than 90 degrees;
radiating a visible light from a lower part of the first side surface and the second side surface to the first side surface and the second side surface; and
radiating an infrared light from an upper part of the living body.

13. The authentication method according to claim 9, further comprising:
forming a first side surface and a second side surface of the prism body such that an angle made by the living body contact surface is to be smaller than 90 degrees; and
radiating a visible light and an infrared light from a lower part of the first side surface and the second side surface to the first side surface and the second side surface.

14. The prism body according to claim 7, wherein the living body is a human's finger.

15. The authentication method according to claim 9, wherein the living body is a human's finger.
